(19) United States
(12) Patent Application Publication
(10) Pub. No.: US 2026/0202787 A1
(43) Pub. Date: Jul. 16, 2026

(54) IMAGE FORMING APPARATUS

(71) Applicant: KYOCERA Document Solutions Inc., Osaka (JP)

(72) Inventors: Kaori KATSUMOTO, Osaka (JP); Yuya SHIMOHORA, Osaka (JP)

(73) Assignee: KYOCERA Document Solutions Inc., Osaka (JP)

(21) Appl. No.: 19/439,849

(22) Filed: Jan. 5, 2026

(30) Foreign Application Priority Data
Jan. 15, 2025 (JP) 2025-005506

(51) Int. Cl. G03G 15/00

(52) U.S. Cl. CPC G03G 15/6567; G03G 2215/00708

(57) ABSTRACT

When a paper dust collecting member is moved in the removal direction, a scraping member scrapes off paper dust adhered to the paper dust collecting member. The paper dust collecting member has a contact member and a holding member. The contact member makes contact with a pair of rollers to collect paper dust. The holding member holds the contact member. The apparatus body has a bottom wall portion. The bottom wall portion is disposed below the paper dust collecting member and extends along the insertion-removal direction to receive the scraped-off paper dust. The paper dust scraped off onto the bottom wall portion is swept out in the insertion direction by the holding member when the paper dust collecting member is inserted.

### INCORPORATION BY REFERENCE

This application is based on and claims the benefit of priority from Japanese Patent Application No. 2025-005506 filed on January 15, 2025, the contents of which are hereby incorporated by reference.

### BACKGROUND

The present disclosure relates to an image forming apparatus provided with a pair of rollers for conveying a sheet and a paper dust collecting member for collecting paper dust adhered to the pair of rollers.

Conventional image forming apparatuses include a pair of rollers, a paper dust collecting member, and a scraping member. The pair of rollers is disposed in an apparatus body and nips a sheet to convey it. The paper dust collecting member is movable in the insertion-removal direction along the axial direction of the pair of rollers. It is disposed in contact with one roller of the pair of rollers to collect paper dust adhered to the pair of rollers. When the paper dust collecting member is moved in the removal direction, the scraping member scrapes off paper dust adhered to the paper dust collecting member. The paper dust scraped off by the scraping member gathers below the scraping member and is collected in the form of a lump.

Inconveniently, with the above configuration, paper dust that falls at locations other than below the scraping member may not be collected. This can reduce the efficiency of collecting paper dust.

An object of the present disclosure is to provide an image forming apparatus that can improve the efficiency of collecting paper dust.

### SUMMARY

To achieve the above object, according to a first configuration of the present disclosure, an image forming apparatus includes a pair of rollers, a paper dust collecting member, a scraping member, and a paper dust receiving portion. The pair of rollers is disposed in the apparatus body and nips a sheet to convey it. The paper dust collecting member is movable in the insertion-removal direction along the axial direction of the pair of rollers. It is disposed in contact with one roller of the pair of rollers to collect paper dust adhered to the pair of rollers. When the paper dust collecting member is moved in the removal direction, the scraping member scrapes off paper dust adhered to the paper dust collecting member. The paper dust collecting member has a contact member and a holding member. The contact member makes contact with the pair of rollers to collect the paper dust. The holding member holds the contact member. The apparatus body has a bottom wall portion. The bottom wall portion is disposed below the paper dust collecting member and extends along the insertion-removal direction to receive the scraped-off paper dust. The paper dust scraped off onto the bottom wall portion is swept out in the insertion direction by the holding member when the paper dust collecting member is inserted.

Further objects of the present disclosure and specific advantages achieved according to the present disclosure become more apparent from the following description of the embodiment.

### BRIEF DESCRIPTION OF THE DRAWINGS

FIG. 1 is a sectional view schematically showing the construction of an image forming apparatus according to one embodiment of the present disclosure.

FIG. 2 is a sectional view, as seen from the axial direction, of a pair of registration rollers and a paper dust collecting member in the image forming apparatus according to one embodiment of the present disclosure.

FIG. 3 is a perspective view of the paper dust collecting member in the image forming apparatus according to one embodiment of the present disclosure.

FIG. 4 is a perspective view of a housing of the image forming apparatus according to one embodiment of the present disclosure.

FIG. 5 is a perspective view of the housing of the image forming apparatus according to one embodiment of the present disclosure.

FIG. 6 is a vertical sectional view schematically showing a state of the paper dust collecting member during its movement for insertion and removal according to one embodiment of the present disclosure.

FIG. 7 is a vertical sectional view schematically showing a state of the paper dust collecting member during its movement for insertion and removal according to one embodiment of the present disclosure.

### DETAILED DESCRIPTION

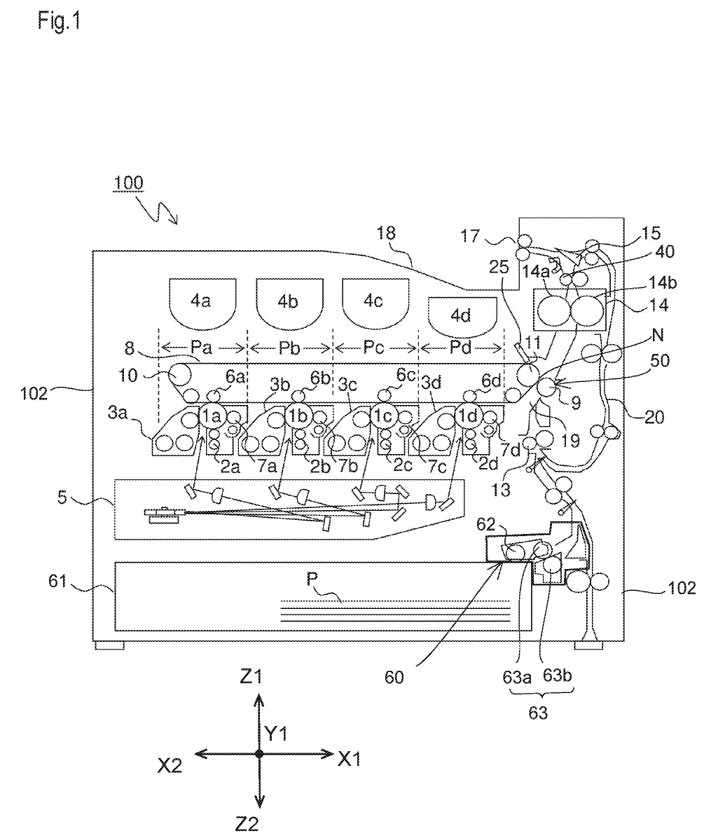

An embodiment of the present disclosure will be described below with reference to the accompanying drawings. FIG. 1 is a sectional view schematically showing the construction of an image forming apparatus 100 according to a first embodiment of the present disclosure. For convenience’ sake, in an installed state (the state shown in FIG. 1) of the image forming apparatus 100 in which it is usable, the vertical direction is defined as the top-bottom direction (Z1-Z2). With the face of the image forming apparatus 100 at the near side of the plane of FIG. 1 defined as the front side (fore side), the front-rear direction (Y1-Y2) is defined. With respect to the front side of the image forming apparatus 100 in its installed state, the left-right direction (X1-X2) is defined. In this embodiment, the left-right direction (X1-X2) is orthogonal to the top-bottom direction (Z1-Z2) and to the front-rear direction (Y1-Y2). The left-right direction (X1-X2) is the direction in which a pair of side faces of the image forming apparatus 100 face each other, and the front-rear direction (Y1-Y2) is the axial direction of a pair of registration rollers 13. This definition of the top-bottom direction is not meant to limit any directions and positional relationships in the image forming apparatus 100 in use.

The image forming apparatus 100 includes image forming portions Pa to Pd, a sheet feed unit 60, a transfer portion 50, a fixing portion 14, a discharge portion 17, a pair of conveying rollers 40, a sheet conveying passage 19, and a branch conveying passage 30.

In the body of the image forming apparatus 100 (here, a color printer), four image forming portions Pa, Pb, Pc, and Pd are arranged in this order from upstream (left side in FIG. 1) along the conveying direction. The image forming portions Pa to Pd form an image on a sheet (recording medium) P.

More specifically, the image forming portions Pa to Pd are provided for images of four different colors (yellow, cyan, magenta, and black). The image forming portions Pa to Pd sequentially form a yellow, a cyan, a magenta, and a black images respectively, each through the processes of electrostatic charging, exposure to light, image development, and image transfer.

The image forming portions Pa to Pd form visible images (toner images) of the corresponding colors on photosensitive drums (image carrying members) 1a to 1d. An intermediate transfer belt (intermediate transfer member) 8 that rotates counterclockwise in FIG. 1 is provided adjacent to the four image forming portions Pa to Pd. The toner images formed on the photosensitive drums 1a to 1d are primarily transferred sequentially to the intermediate transfer belt 8, which moves while in contact with the photosensitive drums 1a to 1d, so as to be superimposed on each other.

The transfer portion 50 transfers the toner images formed on the image forming portions Pa to Pd to the sheet P (recording medium). The transfer portion 50 has a driving roller 11 and a secondary transfer roller 9. Specifically, the toner images primarily transferred to the intermediate transfer belt 8 are secondarily transferred to the sheet P as one example of a recording medium by the secondary transfer roller 9. The sheet P having the toner images secondarily transferred to it then has the toner images fixed to it in the fixing portion 14 and is then discharged out of the body of the image forming apparatus 100.

The sheet feed unit 60 feeds the sheet P to the image forming portions Pa to Pd. Specifically, the sheet feed unit 60 has a pick-up roller 62, a feed roller 63a, and a retard roller 63b. The sheet feed unit 60 is disposed above Z1 of a sheet cassette 61. The sheet cassette 61 is disposed in a lower part of the body of the image forming apparatus 100 and stores the sheet P to which the toner image is to be secondarily transferred.

The pick-up roller 62 is kept in pressed contact with the front side of the sheet P with a predetermined pressure. Rotating the pick-up toller 62 starts the feeding of the sheet P. That is, the pick-up roller 62 makes contact with the sheet (recording medium) P stored in the sheet cassette 61 to feed it out to the sheet conveying passage 19.

The feed roller 63a and the retard roller 63b constitute a pair of feed rollers 63. The feed roller 63a conveys the sheet (recording medium) P fed out by the pick-up roller 62. The retard roller 63b is kept in pressed contact with the feed roller 63a to form a nip portion and conveys the sheet (recording medium) P while separating one from another.

Used as the intermediate transfer belt 8 is a sheet of a dielectric resin, typically a belt with no seams (seamless belt). Downstream of the secondary transfer roller 9, a blade-form belt cleaner 25 is disposed for removing the toner, and the like remaining on the surface of the intermediate transfer belt 8.

Around and below the photosensitive drums 1a to 1d, which are rotatably arranged, there are provided charging devices 2a, 2b, 2c, and 2d, an exposure device 5, development devices 3a, 3b, 3c, and 3d, and cleaning devices 7a, 7b, 7c, and 7d. The charging devices 2a, 2b, 2c, and 2d electrostatically charge the photosensitive drums 1a to 1d. The exposure device 5 exposes the photosensitive drums 1a to 1d to light conveying image information. The development devices 3a, 3b, 3c, and 3d form toner images on the photosensitive drums 1a to 1d. The cleaning devices 7a, 7b, 7c, and 7d remove the developer(toner) and the like remaining on the photosensitive drums 1a to 1d.

When image data is input from a host device such as a personal computer, first, the surfaces of the photosensitive drums 1a to 1d are electrostatically charged uniformly by the charging devices 2a to 2d. After that, the exposure device 5 shines light according to the image data onto the photosensitive drums 1a to 1d to form on them electrostatic latent images corresponding to the image data. The developing devices 3a to 3d are loaded with predetermined amounts of two-component developer containing yellow, cyan, magenta, and black toner. When the proportion of toner in the two-component developer in the developing devices 3a to 3d falls below a prescribed amount as toner images are formed, toner is supplied from toner containers 4a to 4d to the developing devices 3a to 3d.

The toner in the developer is supplied to the photosensitive drums 1a to 1d by the developing devices 3a to 3d and attaches to them electrostatically. This forms toner images corresponding to the electrostatic latent images formed by exposure to light from the exposure device 5.

Then, primary transfer rollers 6a to 6d produce electric fields with a predetermined voltage between themselves and the photosensitive drums 1a to 1d, and the yellow, cyan, magenta, and black toner images on the photosensitive drums 1a to 1d are primarily transferred to the intermediate transfer belt 8. These images are formed in a predetermined positional relationship previously determined. After that, in preparation for the subsequent formation of new electrostatic latent images, the toner and the like remaining on the surfaces of the photosensitive drums 1a to 1d after primary transfer are removed by the cleaning devices 7a to 7d.

The intermediate transfer belt 8 is stretched across a driven roller 10 at the upstream side and the driving roller 11 at the downstream side. When the intermediate transfer belt 8 starts to rotate counterclockwise as a belt driving motor (not illustrated) rotates the driving roller 11, a sheet P is conveyed, with predetermined timing, from the pair of registration rollers 13 to the secondary transfer nip portion N between the driving roller 11 and the secondary transfer roller 9 adjacent to it. The toner images on the intermediate transfer belt 8 are secondarily transferred to the sheet P passing through the secondary transfer nip portion N.

The sheet P having the toner images secondarily transferred to it is conveyed to the fixing portion 14. The fixing portion 14 has a fixing belt 14a and a pressing roller 14b. The fixing belt 14b is heated by a heating device (not illustrated) such as a heater or an induction heating portion. The pressing roller 14b is kept in pressed contact with the fixing belt 14a to form the fixing nip and gives the fixing belt 14a a rotational driving force.

The sheet P conveyed to the fixing portion 14 is heated and pressed by the fixing belt 14a and the pressing roller 14b to have the toner images fixed to the surface of the sheet P to form a predetermined full-color image.

The sheet P having the full-color image formed on it passes through the pair of conveying rollers 40 and then has its conveying direction switched by a conveying guide member 15 disposed at a branch portion of the sheet conveying passage 19. The sheet P is then discharged to a discharge tray 18 by a pair of discharge rollers (the discharge portion) 17 as it is (or after being sent to the branch conveying passage 30 to have images printed on both sides).

The pair of conveying rollers 40 conveys the sheet (recording medium) P from the fixing portion 14 to the pair of discharge rollers (discharge portion) 17.

The sheet conveying passage 19 connects together the sheet feed unit 60, the transfer portion 50, the fixing portion 14, and the discharge portion 17. The branch conveying passage 30 branches off the sheet conveying passage 19 downstream of the pair of conveying rollers 40 and joins the sheet conveying passage 19 upstream of the pair of registration rollers 13. The branch conveying passage 30 extends in the top-bottom direction (Z1-Z2) along a side face 102 of the image forming apparatus 100 and is curved substantially in a C-chape.

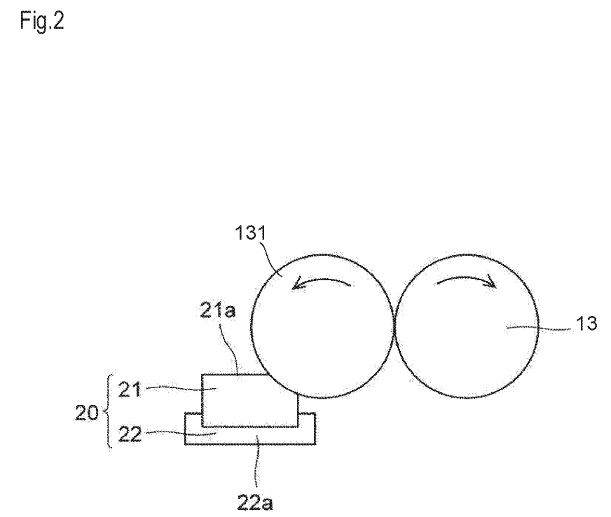

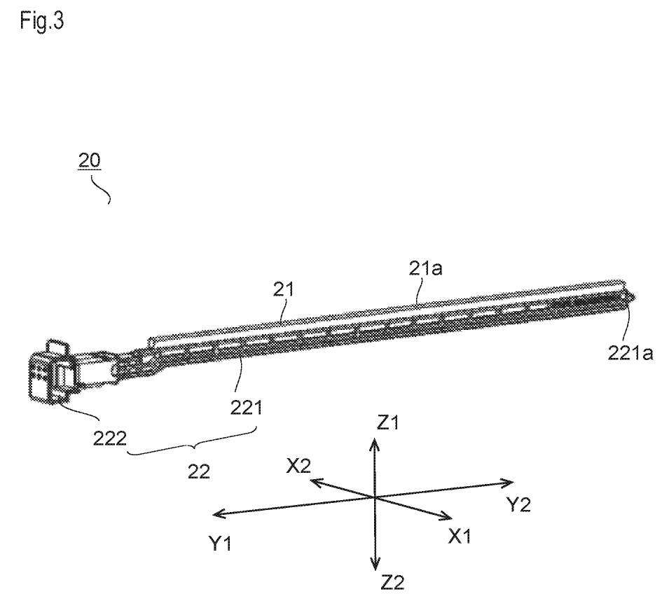

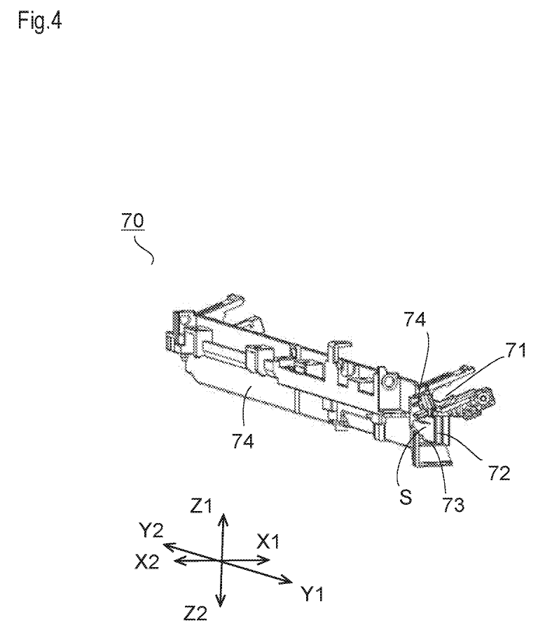

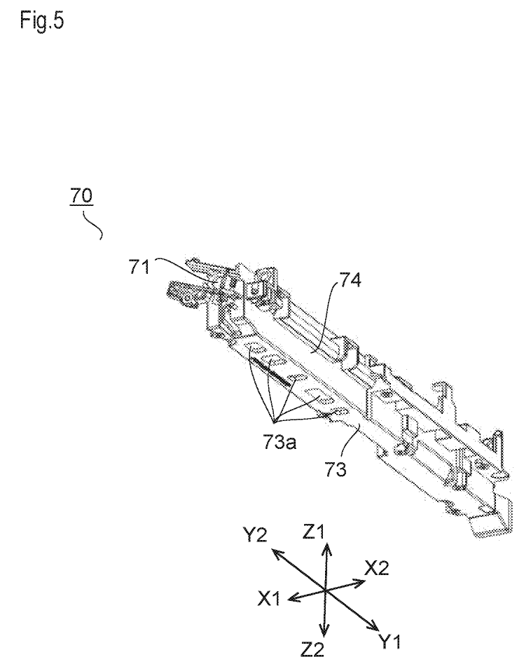

FIG. 2 is a sectional view showing the pair of registration rollers 13 and a paper dust collecting member 20 as seen from the axial direction. FIGS. 3 and 4 are perspective views of a housing 70 that houses one roller 131 of the pair of registration rollers 13 and the paper dust collecting member 20. FIG. 4 shows the housing 70 as seen from below. FIG. 5 is a perspective view of the housing 70.

The image forming apparatus 1 includes the pair of registration rollers 13, the paper dust collecting member 20, the housing (apparatus body) 70, a scraping member 79, and a paper dust receiving portion 80. The two rollers are disposed parallel to each other and are kept in pressed contact with each other to form a nip portion. The pair of registration rollers 13 corrects a skew of the sheet P by having the leading end of the sheet P brought into contact with the nip portion. The pair of registration rollers 13 is rotated by an unillustrated driving motor to convey the sheet P to the secondary transfer nip portion N in synchronization with the timing of image formation.

The paper dust collecting member 20 is disposed near the pair of registration rollers 13. The paper dust collecting member 20 extends in the axial direction along the pair of registration rollers 13 and is movable in the Y1-Y2 direction along the axial direction of the pair of registration rollers 13 (hereinafter referred to as the axial direction) for insertion and removal. Furthermore, the paper dust collecting member 20 is disposed in contact with the circumferential surface of one roller 131 of the pair of registration rollers 13 to collect paper dust adhered to the pair of registration rollers 13.

The paper dust collecting member 20 has a contact member 21 and a holding member 22. The contact member 21 makes contact with one roller 131 of the pair of registration rollers 13 (e.g., the metal roller, the left roller in FIG. 2) to collect paper dust and is formed of, for example, sponge.

The holding member 22 holds the contact member 21 and is a resin-molded part. The contact member 21 is formed in the shape of a rectangular parallelopiped that extends along the axial direction and is fixed to the holding member 22 with adhesive. The upper surface 21a of the contact member 21 is a collecting surface that makes contact with the pair of registration rollers 13 to collect paper dust.

The holding member 22 has a holding portion 221 and a grip portion 222 (see FIG. 3). The holding portion 221 extends along the axial direction (Y1-Y2) and holds the contact member 21. The grip portion 222 is disposed at the removal direction Y1 side of the holding portion 221 and is gripped with fingers when the paper dust collecting member 20 is inserted or removed.

The holding portion 221 (holding member 22) has a protrusion 221a. The protrusion 221a protrudes along the width direction (X1-X2) from a tip end part of the holding portion 221 at the insertion direction Y2 side of the holding portion 221. The width direction (X1-X2) is orthogonal to the top-bottom direction (Z1-Z2) and to the insertion-removal direction (Y1-Y2).

The housing 70 rotatably holds one roller 131 of the pair of registration rollers 13 and houses the paper dust collecting member 20. The housing 70 is a resin-molded part and constitutes part of the apparatus body of the image forming apparatus 100. The housing 70 (apparatus body) has a bottom wall portion 73 and a side wall portion 74. The housing 70 has two insertion holes 71 in which a shaft (not illustrated) of the roller 131 is inserted. The roller 131 rotates about its rotational axis C.

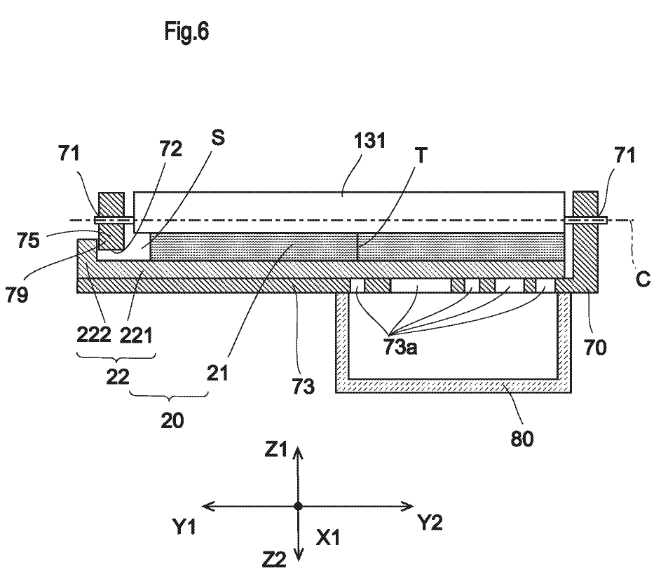

The bottom wall portion 73 is in a rectangular shape as seen from above and is disposed below Z2 the paper dust collecting member 20. The bottom wall portion 73 has a through hole 73a that penetrates it along the top-bottom direction (Z1-Z2). In the embodiment, a plurality of through holes 73a are formed. The through hole 73a is disposed at the insertion direction Y2 side of the middle T, along the insertion-removal direction (Y1-Y2), of the contact member 21 in the inserted state (see FIG. 6). The paper dust receiving portion 80 is disposed below Z2 the through hole 73a.

The side wall portion 74 extends upward Z1 from opposite end parts of the bottom wall portion 73 along the left-right direction (X1-X2). The paper dust collecting member 20 is housed in a housing space S enclosed by the bottom wall portion 73 and the pair of side wall portions 74. The housing space S is open at the top face and the roller 131 held in the housing 70 is disposed to face the housing space S.

The housing 70 further has a side wall member 75. The side wall member 75 is disposed in an end part in the housing space S of the removal direction Y1 and has an opening 72. The opening 72 allows the paper dust collecting member 20 to pass through it during its movement for insertion and removal. That is, the paper dust collecting member 20 is removed out of the housing 70 through the opening 72; the paper dust collecting member 20 is inserted into the housing space S through the opening 72.

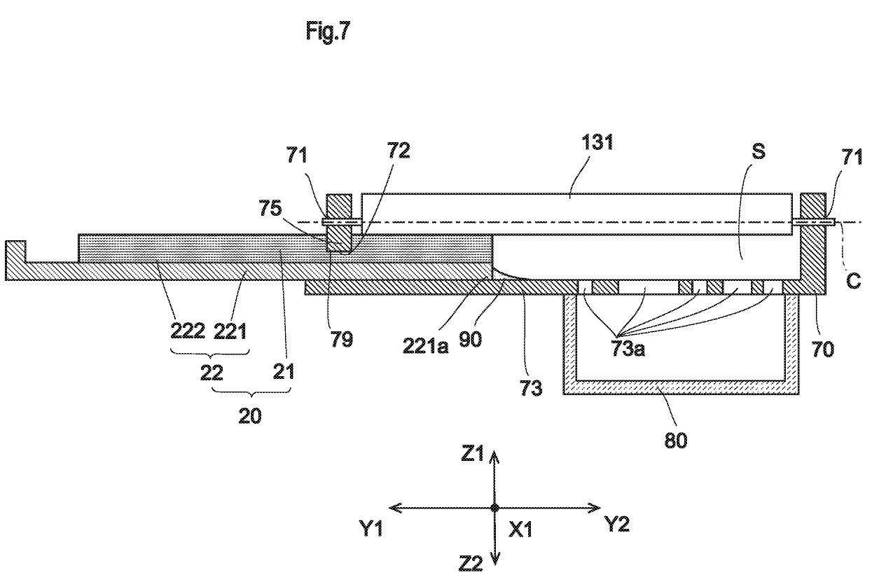

FIGS. 6 and 7 are vertical sectional views showing states of the paper dust collecting member 20 during its movement for insertion and removal. FIG. 6 shows the state where the paper dust collecting member 20 is inserted in the housing space S. FIG. 7 shows the state where the paper dust collecting member 20 having been once removed from the housing space S is being inserted back into it.

The scraping member 79 is disposed at the circumference of the opening 72. In the embodiment, the scraping member 79 protrudes downward (Z2) from the upper end of the circumference of the opening 72. Consequently, when the paper dust collecting member 20 is moved in the removal direction Y1, the contact member 21 makes contact with the scraping member 79. As a result, the scraping member 79 scrapes off paper dust adhered to the paper dust collecting member 20. The paper dust 90 scraped off by the scraping member 79 collects on the upper face of the bottom wall portion 73.

In the embodiment, when the paper dust collecting member 20 is removed, the scraping member 79 scrapes off paper dust adhered to the paper dust collecting member 20. When the paper dust collecting member 20 is inserted, the holding member 221 sweeps out, in the insertion direction Y2, the paper dust 90 scraped off onto the bottom wall portion 73. More specifically, when the paper dust collecting member 20 is inserted, the protrusion 221a slides across the bottom wall portion 73 to sweep out, in the insertion direction Y2, the paper dust 90 scraped off onto the bottom wall portion 73. As a result, the paper dust 90 scraped off from the paper dust collecting member 20 is gathered in the insertion direction Y2 and reliably collected. This improves the efficiency of collecting the paper dust 90. Moreover, the paper dust 90 can be collected through the sequence of operation of inserting and removing the paper dust collecting member 20, and this improves the efficiency of collection.

The paper dust 90 swept out in the insertion direction Y2 falls through the through hole 73a to collect in the paper dust receiving portion 80. Thus, with the paper dust receiving portion 80 removed from the housing 70, the collected paper dust 90 can be easily disposed of. This further improves the efficiency of collecting the paper dust 90.

The through hole 73a is disposed at the insertion direction Y2 side of the middle T, along the insertion-removal direction (Y1-Y2), of the contact member 21 in the inserted state. Thus, the paper dust 90 swept together in the insertion direction Y2 can be dropped in the form of a lump into the paper dust receiving portion 80 to be collected. This further improves the efficiency of collecting the paper dust 90. Furthermore, the paper dust receiving portion 80 can be made compact along the insertion-removal direction (Y1-Y2).

Furthermore, the protrusion 221a is provided to reliably sweep out the paper dust 90 in the insertion direction Y2. This further improves the efficiency of collecting the paper dust 90.

The paper dust receiving portion 80 is disposed below Z2 the through hole 73a to receive the paper dust 90 falling through it (see FIG. 7).

The embodiment disclosed herein should be understood to be in every aspect illustrative and not meant as any limitation. The scope of the present disclosure is defined not by the above description of the embodiment but by the appended claims, and encompasses any modifications within a scope equivalent in significance to those claims.

For example, while the embodiment described above deals with an example where the present disclosure is applied to a monochrome printer, this is not meant to limit the present disclosure. Needless to say, the present disclosure is applicable to various image forming apparatuses, such as color printers, monochrome copiers, digital multifunction peripherals, and facsimiles, that include a pair of rollers for conveying a sheet and a paper dust collecting member for collecting paper dust adhered to the pair of rollers.

While the embodiment described above deals with an example of a configuration where the paper dust adhered to the pair of registration rollers is collected, this is not meant as any limitation. A configuration is also possible that collects paper dust adhered to a pair of rollers other than the pair of registration rollers.

What is claimed is:

1. An image forming apparatus comprising:
a pair of rollers disposed in an apparatus body, the pair of rollers nipping a sheet to convey the sheet;
a paper dust collecting member that is movable in an insertion-removal direction along an axial direction of the pair of rollers, the paper dust collecting member disposed in contact with one roller of the pair of rollers to collect paper dust adhered to the pair of rollers; and
a scraping member that scrapes off the paper dust adhered to the paper dust collecting member when the paper dust collecting member is moved in a removal direction,
wherein
the paper dust collecting member has:
a contact member that makes contact with the pair of rollers to collect the paper dust,
a holding member that holds the contact member, and
the apparatus body has:
a bottom wall portion disposed below the paper dust collecting member, the bottom wall portion extending along the insertion-removal direction to receive the scraped-off paper dust,
the paper dust scraped off onto the bottom wall portion is swept out in an insertion direction by the holding member when the paper dust collecting member is inserted.

2. The image forming apparatus according to claim 1, wherein
the bottom wall portion has a through hole that penetrates therethrough along a top-bottom direction,
the image forming apparatus further includes a paper dust receiving portion disposed below the through hole to receive the paper dust swept out in the insertion direction and fallen through the through hole.

3. The image forming apparatus according to claim 2, wherein
the through hole is disposed at an insertion direction side of a middle, along the insertion-removal direction, of the contact member in an inserted state.

4. The image forming apparatus according to claim 1, wherein
the holding member has a protrusion that protrudes, from a tip end part thereof at the insertion direction side, along a width direction which is orthogonal to the top-bottom direction and to the insertion-removal direction, and
the protrusion slides across the bottom wall portion when the paper dust collecting member is inserted.

5. The image forming apparatus according to claim 1, wherein
the pair of rollers is a pair of registration rollers that conveys the sheet to an image forming portion in synchronization with timing of image formation while correcting a skew of the sheet.
